(19) United States
(12) Patent Application Publication
(10) Pub. No.: US 2026/0155477 A1
(43) Pub. Date: Jun. 4, 2026

(54) ENERGY STORAGE DEVICE AND METHOD FOR MANUFACTURING ENERGY STORAGE DEVICE

(71) Applicant: TOYOTA JIDOSHA KABUSHIKI KAISHA, Toyota-shi (JP)

(72) Inventors: Osamu YAMASHITA, Toyota-shi (JP); Shinichiro MORI, Nisshin-shi (JP); Koji SHIMIZU, Nagoya-shi (JP); Seigo FUJISHIMA, Miyoshi-shi (JP); Sumiko KITO, Nagoyo-shi (JP); Shinya ISHIKAWA, Anjo-shi (JP); Shintaro TOMITA, Obu-shi (JP); Yuji YAMASHITA, Toyota-shi (JP); Kenta KIMURA, Nagoya-shi (JP)

(73) Assignee: TOYOTA JIDOSHA KABUSHIKI KAISHA, Toyota-shi (JP)

(21) Appl. No.: 19/331,175

(22) Filed: Sep. 17, 2025

(30) Foreign Application Priority Data
Nov. 29, 2024 (JP) 2024-208860

(51) Int. Cl. H01M 10/6554; B60R 16/04; H01M 10/625; H01M 10/647; H01M 10/656; H01M 50/209

(52) U.S. Cl. CPC H01M 10/6554; H01M 10/625; H01M 10/647; H01M 10/656; H01M 50/209; B60R 16/04; H01M 2220/20

(57) ABSTRACT

An energy storage device includes: a plurality of energy storage cells; and two plate-shaped heat exchange plates extending in the longitudinal direction of long side surfaces of the energy storage elements. A connector having an opening is provided at an end of one of the heat exchange plates. The connector protrudes toward an end of the other heat exchange plate. A connector having an opening is provided at the end of the other heat exchange plate. The connector protrudes toward the end of the one heat exchange plate. The energy storage device further includes a connection pipe configured to contract upon heating. The connection pipe covers each of the connectors.

### CROSS-REFERENCE TO RELATED APPLICATION

This application claims priority to Japanese Patent Application No. 2024-208860 filed on Nov. 29, 2024. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

Various technologies related to energy storage devices have been proposed. For example, Japanese Unexamined Patent Application Publication No. 2013-045578 (JP 2013-045578 A) discloses a configuration in which each of a plurality of heat exchangers is disposed between every adjacent ones of a plurality of battery cells, and pipes are connected to the heat exchangers.

### SUMMARY

However, if the manufacturing tolerances of the heat exchangers and the pipes are large, it may not be possible to connect the pipes to the heat exchangers each disposed between adjacent ones of the battery cells. Accordingly, for example, it is conceivable to adopt a configuration in which the pipes are provided with a bellows structure etc. to allow the pipes to deform and absorb the tolerances. However, this requires the work of deforming the pipes for connection. Therefore, the pipe connection work may become difficult when performed in a small space, which can increase the workload associated with the connection work.

The present disclosure has been made in view of the above issue, and an object thereof is to provide an energy storage device and a method for manufacturing an energy storage device that reduces an increase in workload associated with connecting pipes with heat exchangers.

An energy storage device according to one aspect of the present disclosure includes: a plurality of energy storage elements; a first heat exchanger having a plate shape, disposed between the energy storage elements so as to face long side surfaces of the energy storage elements, and extending in a longitudinal direction of the long side surfaces; and a second heat exchanger having a plate shape, disposed so as to face the first heat exchanger, and configured to perform heat exchange with the opposite long side surface of the energy storage element from the long side surface. A first connector is provided at a first end of the first heat exchanger in the longitudinal direction. The first connector has an opening that opens toward a second end of the second heat exchanger in the longitudinal direction. A second connector is provided at the second end. The second connector has an opening that opens toward the first connector. The energy storage device further includes a member configured to contract upon heating. The member covers each of the first connector and the second connector.

In this configuration, each of the first and second connectors is covered with the member configured to contract upon heating. Accordingly, even when a large relative positional deviation occurs between the first and second connectors due to manufacturing tolerances, the member can still cover the first and second connectors, and the attachment can be completed by heating. As a result, an increase in workload associated with attachment of components can be reduced.

In one embodiment, each of the first connector and the second connector is coated with an insulating coating.

In this configuration, each of the first and second connectors is coated with an insulating coating. Accordingly, even when a large relative positional deviation occurs between the first and second connectors due to manufacturing tolerances, exposure of electrically conductive portions can be reduced when the first and second connectors are covered with the member.

In another embodiment, a protrusion is provided at a distal end of the first connector. A recess configured to receive a distal end of the protrusion is provided in a distal end of the second connector.

In this configuration, the distal end of the protrusion of the first connector is inserted into the recess of the second connector. This reduces application of the cooing medium pressure to the member that covers the first and second connectors. It is therefore possible to reduce deterioration in durability of the member due to the cooling medium pressure.

A method for manufacturing an electricity storage device according to another aspect of the present disclosure includes: disposing a first heat exchanger such that the first heat exchanger faces a long side surface of an energy storage element; and disposing a second heat exchanger such that the second heat exchanger faces the first heat exchanger. The first heat exchanger has a plate shape and extends in a longitudinal direction of the long side surface. The second heat exchanger has a plate shape, and is configured to perform heat exchange with the opposite long side surface of the energy storage element from the long side surface. A first connector is provided at a first end of the first heat exchanger in the longitudinal direction. The first connector has an opening that opens toward a second end of the second heat exchanger in the longitudinal direction. A second connector is provided at the second end. The second connector has an opening that opens toward the first connector. The method further includes: attaching, to the first connector, a member configured to contract upon heating; attaching the member to the second connector when disposing the second heat exchanger; and heating the member.

The present disclosure can provide an energy storage device and a method for manufacturing an energy storage device that reduces an increase in workload associated with connecting pipes with heat exchangers.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows a vehicle 1 equipped with an energy storage device 2;

FIG. 2 is an exploded perspective view of the energy storage device 2;

FIG. 3 is a plan view showing a cooling device 12 etc.;

FIG. 4 is a perspective view of the cooling device 12;

FIG. 5 is a flowchart illustrating an example of a method for manufacturing the energy storage device 2; and

FIG. 6 illustrates the configuration of connectors 50A′, 50B′ and a connection pipe 50D in a modification.

### DETAILED DESCRIPTION OF EMBODIMENTS

An embodiment of the present disclosure will be described in detail below with reference to the drawings. The same or corresponding portions are denoted by the same signs throughout the drawings, and description thereof will not be repeated.

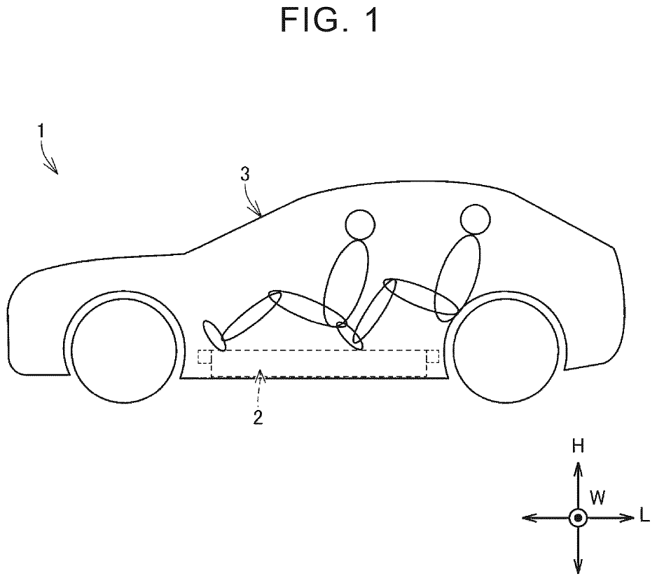

FIG. 1 schematically shows a vehicle 1 equipped with an energy storage device 2. The vehicle 1 includes a vehicle body 3, and the energy storage device 2 is mounted on the bottom of the vehicle body 3.

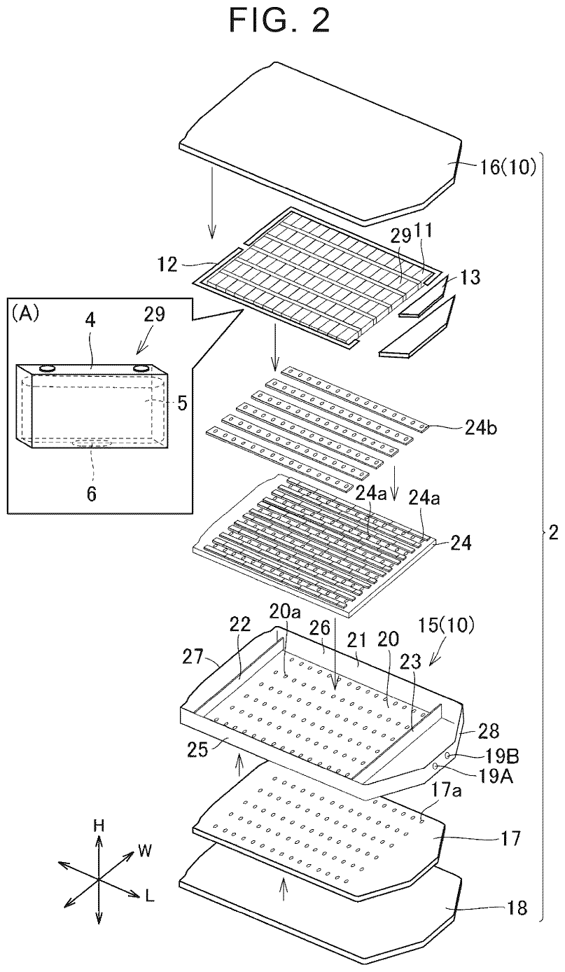

FIG. 2 is an exploded perspective view of the energy storage device 2. In FIG. 2, the width direction W refers to the width direction of the energy storage device 2 and also the width direction of the vehicle 1. The front-rear direction L refers to the front-rear direction of the energy storage device 2 and also the front-rear direction of the vehicle 1. The up-down direction H refers to the up-down direction of the energy storage device 2 and also the up-down direction of the vehicle 1.

The energy storage device 2 includes a housing case 10, an energy storage module 11, a cooling device 12, and an electrical device 13. The housing case 10 includes a lower case 15, an upper case 16, an insulating plate 17, and a share panel 18.

The lower case 15 is formed so as to open upward, and the upper case 16 is provided so as to close the opening of the lower case 15.

The lower case 15 includes a bottom plate 20, a peripheral wall 21, partition walls 22, 23, and an insulating plate 24.

The bottom plate 20 is in the form of a plate. The peripheral wall 21 is formed along the outer peripheral edge of the bottom plate 20. The peripheral wall 21 includes a side wall 25, a side wall 26, an end plate 27, and an end plate 28.

The side walls 25, 26 are arranged in the width direction W. The side walls 25, 26 are formed to extend in the front-rear direction L.

The end plates 27, 28 are spaced apart in the front-rear direction L. The end plates 27, 28 are formed to extend in the width direction W. The end plate 27 connects one end of the side wall 25 and one end of the side wall 26, and the end plate 28 connects the opposite end of the side wall 25 and the opposite end of the side wall 26.

Each of the side walls 25, 26 and the end plates 27, 28 is provided with a fixing portion that will be described later, and each of the fixing portions is fixed to the vehicle body 3.

The partition walls 22, 23 are disposed within a region surrounded by the bottom plate 20 and the peripheral wall 21. The partition wall 22 is disposed adjacent to the end plate 27, and is formed to extend in the width direction W.

The partition wall 23 is disposed at a distance from the end plate 28 in the front-rear direction L. The end plate 28 is also formed to extend in the width direction W.

Breathing membranes 19A, 19B are provided on the end plate 28. The breathing membranes 19A, 19B are waterproof, breathable membranes. The breathing membranes 19A, 19B are made of a material such as GORE-TEX.

The insulating plate 24 is disposed on a portion of the upper surface of the bottom plate 20 located between the partition walls 22, 23. The insulating plate 24 has a plurality of openings 24a. The insulating plate 24 is provided with an insulating protector 24b that closes the openings 24a.

The insulating plate 17 is fixed to the lower surface of the bottom plate 20, and the insulating plate 17 also has a plurality of openings 17a.

The bottom plate 20 also has a plurality of openings 20a. The openings 24a, the openings 20a, and the openings 17a are aligned in the up-down direction.

The share panel 18 is disposed under the insulating plate 17, and the outer peripheral edge of the share panel 18 is fixed to the lower surface of the bottom plate 20. The share panel 18 is formed to cover the insulating plate 17 and the lower surface of the bottom plate 20.

The energy storage module 11 is disposed on the upper surface of the insulating plate 24. The electrical device 13 is disposed between the partition wall 23 and the end plate 28.

The energy storage module 11 includes a plurality of energy storage cells 29. The energy storage cells 29 are arranged at intervals in the front-rear direction L and also arranged at intervals in the width direction W. Each of the energy storage cells 29 may be a nickel metal hydride cell or a lithium-ion cell, or may be an energy storage element such as a capacitor.

A perspective view of the energy storage cell 29 is shown in (A) of FIG. 2. The energy storage cell 29 includes a cell case 4 and an electrode assembly 5 housed in the cell case 4. The cell case 4 includes a bottom plate, and a vent valve 6 is formed in the bottom plate of the cell case 4. Each of the energy storage cells 29 is arranged such that its vent valve 6 is located above a corresponding one of the openings 24a of the insulating plate 24 shown in FIG. 2.

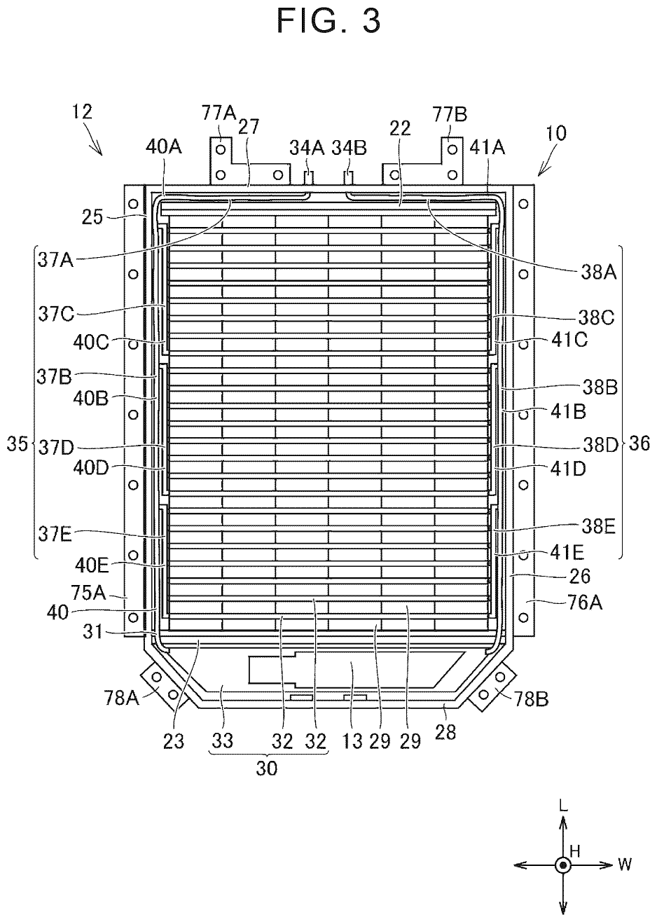

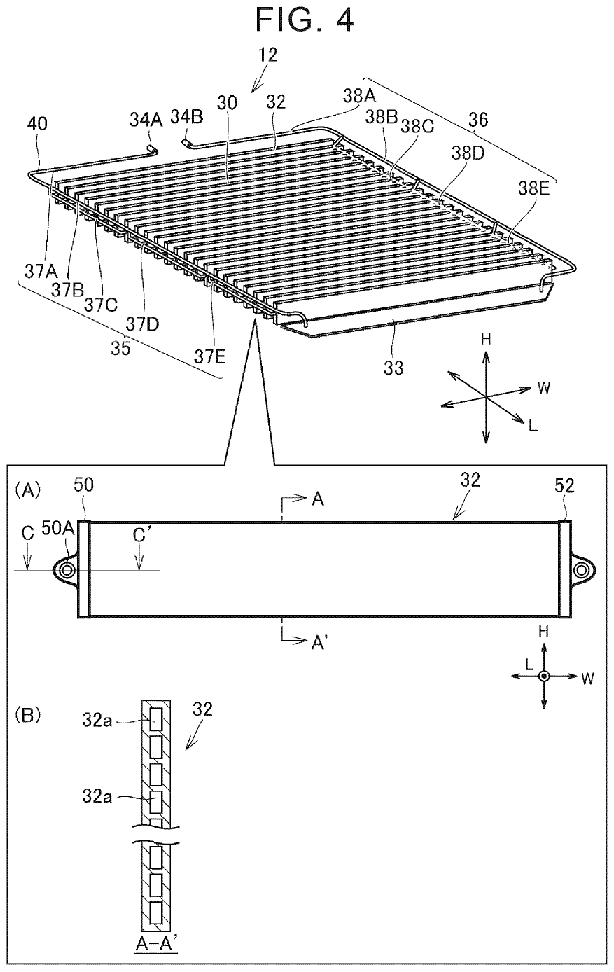

FIG. 3 is a plan view showing the cooling device 12 etc., and FIG. 4 is a perspective view of the cooling device 12. The energy storage cells 29 etc. are not shown in FIG. 4.

Referring to FIGS. 3 and 4, the cooling device 12 includes a heat exchanger 30, a cooling medium pipe 31, and a thermal insulating member 40. The heat exchanger 30 includes a plurality of heat exchange plates 32 and a heat exchange plate 33.

The heat exchange plates 32 are arranged at intervals in the front-rear direction L. Each of the heat exchange plates 32 is disposed to extend in the width direction W. Multiple energy storage cells 29 arranged in the width direction W are disposed between the heat exchange plates 32 adjacent to each other in the front-rear direction L. That is, each of the heat exchange plates 32 is disposed between the energy storage cells 29 so as to face the side surfaces in the longitudinal direction (width direction W) (hereinafter referred to as “long side surfaces”) of the energy storage cells 29. The heat exchange plates 32 are provided to extend in the longitudinal direction (width direction W) of the long side surfaces of the energy storage cells 29.

The cooling medium pipe 31 is disposed in the housing case 10. The cooling medium pipe 31 includes a supply pipe 35 and a discharge pipe 36.

The supply pipe 35 is connected to a supply portion 34A. The supply portion 34A is inserted into an insertion hole 39A formed in the end plate 27, and is fixed to the end plate 27.

The supply pipe 35 includes a main supply pipe 37A, a main supply pipe 37B, and branch pipes 37C, 37D, 37E.

The main supply pipe 37A is disposed between the partition wall 22 and the end plate 27, and is arranged to extend in the width direction W. The main supply pipe 37A is formed to extend toward the side wall 25.

The main supply pipe 37B is connected to an end of the main supply pipe 37A, and is formed to extend in the front-rear direction L along the side wall 25.

Each of the branch pipes 37C, 37D, 37E is disposed below the main supply pipe 37B, and is connected to the main supply pipe 37B. The branch pipes 37C, 37D, 37E are arranged at intervals in the front-rear direction L.

The connection portions between the main supply pipe 37B and each of the branch pipes 37C, 37D, 37E are provided at intervals in the front-rear direction L.

Multiple heat exchange plates 32 arranged at intervals in the front-rear direction L are connected to the branch pipe 37C. More specifically, the branch pipe 37C is constituted by connection portions of the multiple heat exchange plates 32 and connection pipes. The connection portion of each heat exchange plate 32 is provided for connection to adjacent heat exchange plates 32. Each connection pipe connects between the connection portions of adjacent heat exchange plates 32. The connection portion of each heat exchange plate 32 includes a supply port that communicates with the interior of the heat exchange plate 32, and a connection port for connection to adjacent heat exchange plates 32. Similarly, multiple heat exchange plates 32 arranged at intervals in the front-rear direction L are connected to the branch pipe 37D, and multiple heat exchange plates 32 arranged at intervals in the front-rear direction L are connected to the branch pipe 37E. Each of the branch pipes 37D, 37E is similarly constituted by connection portions of the multiple heat exchange plates 32 and connection pipes each connecting between the connection portions of adjacent heat exchange plates 32.

The heat exchange plate 33 is connected to the end of the main supply pipe 37B on the end plate 28 side. The heat exchange plate 33 is disposed on a portion of the upper surface of the bottom plate 20 located between the partition wall 23 and the end plate 28. An insulating plate is disposed between the heat exchange plate 33 and the bottom plate 20. The electrical device 13 is disposed on the upper surface of the heat exchange plate 33. The electrical device 13 includes, for example, a battery electronic control unit (ECU) and a junction box.

The discharge pipe 36 includes a main discharge pipe 38A, a main discharge pipe 38B, and branch pipes 38C, 38D, 38E.

The discharge pipe 36 is connected to a discharge portion 34B. The discharge portion 34B is inserted into an insertion hole 39B formed in the end plate 27, and is fixed to the end plate 27. The insertion holes 39A, 39B are formed spaced apart from each other in the width direction W.

The main discharge pipe 38A is disposed between the partition wall 22 and the end plate 27. The main discharge pipe 38A is arranged to extend in the width direction W, and is formed to extend toward the side wall 26.

The main discharge pipe 38B is connected to an end of the main discharge pipe 38A, and is formed to extend along the side wall 26.

Each of the branch pipes 38C, 38D, 38E is disposed below the main discharge pipe 38B, and is connected to the main discharge pipe 38B. The branch pipes 38C, 38D, 38E are arranged at intervals in the front-rear direction L.

Multiple heat exchange plates 32 arranged at intervals in the front-rear direction L are connected to the branch pipe 38C. Similarly, multiple plate-shaped heat exchange plates 32 arranged at intervals in the front-rear direction L are connected to the branch pipe 38D, and multiple plate-shaped heat exchange plates 32 arranged at intervals in the front-rear direction L are connected to the branch pipe 38E. The heat exchange plate 33 is connected to the end of the main discharge pipe 38B on the end plate 28 side. Since the specific configurations of the branch pipes 38C, 38D, 38E are similar to those of the branch pipes 37C, 37D, 37E, detailed description thereof will not be repeated.

The thermal insulating member 40 includes thermal insulating members 40A, 40B, 40C, 40D, 40E, and thermal insulating members 41A, 41B, 41C, 41D, 41E.

The thermal insulating member 40A covers the main supply pipe 37A. The thermal insulating member 40B covers the main supply pipe 37B. Similarly, the thermal insulating members 40C, 40D, 40E cover the branch pipes 37C, 37D, 37E, respectively. The thermal insulating members 41A, 41B cover the main discharge pipes 38A, 38B, respectively. The thermal insulating members 41C, 41D, 41E cover the branch pipes 38C, 38D, 38E, respectively.

As shown in FIG. 3, a fixing portion 75A is formed on the outer surface of the side wall 25. Similarly, a fixing portion 76A is formed on the outer surface of the side wall 26.

Fixing portions 77A, 77B are formed on the outer surface of the end plate 27, and fixing portions 78A, 78B are formed on the outer surface of the end plate 28.

The fixing portions 77A, 77B are fixed to the vehicle body 3 by fastening members. For example, the vehicle body 3 includes side sills arranged spaced apart from each other in the width direction W, a cross member connecting the side sills, and a floor panel. The fixing portions 77A, 77B are fixed to the cross member. The fixing portions 77A, 77B may alternatively be fixed to the floor panel.

The fixing portion 75A is formed so as to protrude in the width direction W from the outer surface of the side wall 25. The fixing portion 76A is formed so as to protrude in the width direction W from the outer surface of the side wall 26. The fixing portion 75A is fixed to one of the side sills of the vehicle body 3 by fastening members, and the fixing portion 76A is fixed to the other side sill of the vehicle body 3 by fastening members.

The energy storage device 2 configured as above will now be described. Referring to FIG. 2, when the energy storage module 11 is cooled, a cooling medium C is supplied to the cooling device 12. Referring to FIG. 3, the cooling medium C is supplied from the supply portion 34A into the supply pipe 35. Specifically, the cooling medium C is supplied into the main supply pipe 37A. The cooling medium C then enters the main supply pipe 37B. Part of the cooling medium C introduced into the main supply pipe 37B enters the branch pipes 37C, 37D, 37E.

The cooling medium C introduced into the branch pipe 37C is supplied to the connection portions (upstream connection ports) of the multiple heat exchange plates 32 connected to the branch pipe 37C. Similarly, the cooling medium C introduced into the branch pipe 37D is supplied to the connection portions (upstream connection ports) of the multiple heat exchange plates 32 connected to the branch pipe 37D. The cooling medium C introduced into the branch pipe 37E is supplied to the connection portions (upstream connection ports) of the multiple heat exchange plates 32 connected to the branch pipe 37E. The cooling medium C thus supplied to the connection portions is supplied into the interiors of the heat exchange plates 32 through supply ports, and is further supplied to the connection portions of their adjacent heat exchange plates 32 through downstream connection portions. Regarding the heat exchange plate 32 located at the downstream end of the branch pipes 37C, 37D, 37E, the cooling medium C supplied to the connection portion is supplied into the interior of the heat exchange plate 32 through a supply port.

The cooling medium C is thus supplied into the interiors of the heat exchange plates 32, whereby the energy storage cells 29 arranged between the heat exchange plates 32 are cooled. On the other hand, the cooling medium C flowing through the heat exchange plates 32 is heated by heat from the energy storage cells 29.

The heat exchange plates 32 are connected to the branch pipes 38C, 38D, 38E, and the cooling medium C heated in the heat exchange plates 32 flows into the branch pipes 38C, 38D, 38E.

The branch pipes 38C, 38D, 38E are connected to the main discharge pipe 38B. The cooling medium C passes through the main discharge pipes 38B, 38A and is then discharged to the outside of the housing case 10 from the discharge portion 34B. The discharge portion 34B is connected to a radiator, not shown, etc., and the cooling medium C is cooled by the radiator etc. The cooling medium C thus cooled is then supplied again to the supply portion 34A.

The heat exchange plate 33 is connected to the end of the main supply pipe 37B, and the electrical device 13 is cooled by the heat exchange plate 33. The heat exchange plate 33 is connected to the end of the main discharge pipe 38B, and the cooling medium C flowing through the heat exchange plate 33 enters the main discharge pipe 38B.

In the energy storage device 2 configured as described above, each of the heat exchange plates 32 is disposed between the energy storage cells 29, and a connection pipe is provided to connect two adjacent heat exchange plates 32. It is desired that the connection pipe can be attached to the connection portions of the heat exchange plates 32 that are formed by connectors etc., and that the connection pipe be formed with high precision such that the cooling medium will not leak from between the connection pipe and each of the connection portions.

However, if the manufacturing tolerances of the connection portions of the heat exchange plates 32 or the connection pipe are large, the connection pipe may not be connectable to the connection portions of the heat exchange plates 32. Accordingly, for example, it is conceivable to adopt a configuration in which the connection pipe is provided with a bellows structure etc. to allow deformation and absorb the tolerances. However, this requires deforming the connection pipe for connection. Therefore, for example, when the connection is performed in a small space, attachment of the connection pipe may become difficult, resulting in an increased workload.

Therefore, in the present embodiment, a material that contracts upon heating is used as the connection pipe to cover the space between the connection portions of two adjacent heat exchange plates 32.

In this configuration, the space between the connection portions of two adjacent heat exchange plates 32 is covered by the connection pipe that contracts upon heating. Accordingly, even when a large relative positional deviation occurs between the connection portions of the two heat exchange plates 32 due to manufacturing tolerances, the connection pipe can still cover the connection portions, and the attachment can be completed by heating. As a result, an increase in workload associated with attachment of components can be reduced.

A specific configuration of the connection portions of the heat exchange plate 32 of the energy storage device 2 according to the present embodiment will now be described with reference to (A) of FIG. 4.

An example of the configuration of the heat exchange plate 32 is shown in (A) of FIG. 4. As shown in (A) of FIG. 4, the heat exchange plate 32 has a rectangular shape as viewed in the front-rear direction L. The heat exchange plate 32 is made of, for example, a highly thermally conductive metal such as aluminum, or a resin.

A connection portion 50 that is connected to the supply pipe 35 is provided at one end of the heat exchange plate 32 in the width direction W. A connection portion 52 that is connected to the discharge pipe 36 is provided at the other end of the heat exchange plate 32 in the width direction W. Therefore, the cooling medium supplied from the connection portion 50 with the supply pipe 35 flows through the channel inside the heat exchange plate 32 from one end to the other end. The cooling medium is then discharged from the connection portion 52 to the discharge pipe 36.

The heat exchange plate 32 has a hollow internal structure. The heat exchange plate 32 is manufactured by attaching the connection portions 50, 52 to a hollow aluminum member formed by, for example, extrusion.

A plurality of separating walls is provided in the hollow interior of the heat exchange plate 32. A plurality of cooling medium channels is formed in the interior of the heat exchange plate 32 by the separating walls. An example of a cross-section of the heat exchange plate 32 is shown in (B) of FIG. 4. A cross-section of the heat exchange plate 32 taken along line A-A′ is shown in (B) of FIG. 4. As shown in (B) of FIG. 4, the heat exchange plate 32 includes a plurality of channels 32a formed by the separating walls. The separating walls are arranged at predetermined intervals in the up-down direction H, and are configured as surfaces parallel to a plane defined by the width direction W and the front-rear direction L. The separating walls may be configured as surfaces inclined with respect to this plane.

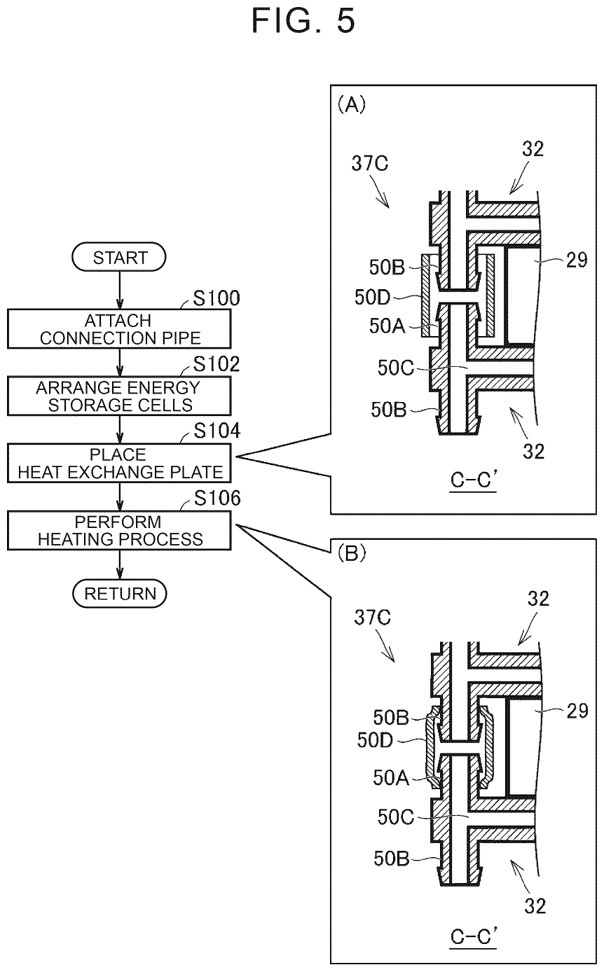

The connection portion 50 includes a connector 50A for connection with an adjacent heat exchange plate 32. The connection portion is further provided with a supply port (not shown) that communicates with the interior of the heat exchange plate 32. The connector 50A is, for example, a cylindrical member (first cylindrical portion) extending in the front-rear direction L. An opening having a circular shape coaxial with the first cylindrical portion is formed so as to extend from the upper surface of the first cylindrical portion to the supply port along the front-rear direction L. The opening communicates with the supply port. Among the heat exchange plates 32, a heat exchange plate 32 having two adjacent heat exchange plates 32 in the front-rear direction L includes a connection portion 50 that further includes a connector 50B (see FIG. 5). The connector 50B is a cylindrical member (second cylindrical portion) extending in the direction opposite to the first cylindrical portion in the front-rear direction L. Since the second cylindrical portion has the same shape as the first cylindrical portion, detailed description thereof will not be repeated.

FIG. 5 is a flowchart illustrating an example of a method for manufacturing the energy storage device 2. FIG. 5 shows, in particular, an example of a method for assembling a connection pipe 50D to the connectors 50A, 50B. In the flowchart of FIG. 5, for example, it is assumed that one heat exchange plates 32 and energy storage cells 29 have already been assembled in the housing case 10.

In step (hereinafter, the term “step” will be abbreviated as S) 100, the connection pipe 50D is attached to the connector 50B of the heat exchange plate 32 that has been assembled in the housing case 10. A cross-section taken along line C-C′ in (A) of FIG. 4 is shown in (A) of FIG. 5. For example, in a case where the upper heat exchange plate 32 has been assembled in the housing case 10 out of the two adjacent heat exchange plates 32 and the connection pipe 50D shown in (A) of FIG. 5, the connection pipe 50D is inserted over and assembled with the connector 50B. The connection pipe 50D has a property of contracting when heated. The connection pipe 50D may be made of, for example, polyvinyl chloride, silicone rubber, or a fluoropolymer. The process then proceeds to S102.

In S102, the long side surfaces of multiple energy storage cells 29 are attached at positions facing the longitudinal surface of the heat exchange plate 32. For example, the multiple energy storage cells 29 may be attached at positions facing the longitudinal surface of the upper heat exchange plate 32 in (A) of FIG. 5, before the connection pipe 50D is attached to the connector 50B. The process then proceeds to S104.

In step S104, a heat exchange plate 32 is attached to the opposite long side surfaces of the multiple energy storage cells 29. At this time, the connector 50A of the heat exchange plate 32 to be attached is inserted into the other end of the connection pipe 50D that has the connector 50B inserted in its one end.

Through such an operation, as shown in (A) of FIG. 5, the energy storage cells 29 are disposed between the two adjacent heat exchange plates 32, and the connection pipe 50D is inserted over both the connector 50B provided at the longitudinal end of one of the heat exchange plates 32 and the connector 50A provided at the longitudinal end of the other heat exchange plate 32. At this time, the opening of the connector 50A opens toward the connector 50B of the adjacent heat exchange plate 32, and the opening of the connector 50B opens toward the connector 50A. In (A) of FIG. 5, a supply port 50C is provided between the connector 50A and the connector 50B in one heat exchange plate 32. As described above, the supply port 50C communicates with the channels formed inside the heat exchange plate 32. The process then proceeds to S106.

In S106, a heating process is performed. Specifically, the connection pipe 50D in the state shown in (A) of FIG. 5 is heated using a heating device such as a heater or a heat gun. As the connection pipe 50D contracts due to the heating, its inner wall comes into contact with the outer peripheral portion of the connector 50B of one of the two adjacent heat exchange plates 32 and the outer peripheral portion of the connector 50A of the other heat exchange plate 32.

As a result, as shown in (B) of FIG. 5, after completion of the heating process, part of the inner wall of the connection pipe 50D is in close contact with the outer peripheral portions of both the connector 50A and the connector 50B.

In the example described above, the connection pipe 50D is used to connect the connector 50A of one connection portion 50 and the connector 50B of another connection portion 50. However, the connection pipe 50D is also used to connect a connector of one connection portion 52 and a connector of another connection portion 52. Detailed description thereof will not be repeated.

By repeating the manufacturing process described above, the connection pipes 50D are assembled between the connectors of all adjacent heat exchange plates 32. Once the connection pipes 50D are assembled in this manner, each connection pipe 50D is in close contact with both the connectors 50A, 50B, thereby allowing the cooling medium to flow through each heat exchange plate 32 while reducing leakage of the cooling medium flowing through the interior. Moreover, even if the relative positional relationship between the connectors 50A, 50B deviates from a predetermined design position in at least one of the width direction W, the up-down direction L, and the vertical direction H when two heat exchange plates 32 are arranged, the connection pipe 50D will still come into close contact with the connectors 50A, 50B. Moreover, since the close contact is achieved by heating, an increase in workload associated with attaching the connection pipes 50D can be reduced.

As described above, in the energy storage device 2 according to the present embodiment, both connectors 50A, 50B are covered with a connection pipe 50D made of a material that contracts upon heating. Accordingly, leakage of refrigerant can be reduced. Moreover, even when a large relative positional deviation occurs between the connectors 50A, 50B due to manufacturing tolerances, the connection pipe 50D can still cover both connectors, and the attachment can be completed by heating. As a result, an increase in the workload associated with attaching the connection pipes 50D can be reduced. It is therefore possible to provide an energy storage device and a method for manufacturing an energy storage device that reduces an increase in workload associated with connecting pipes with heat exchangers even when manufacturing tolerances are large.

Modifications will be described below.

The above embodiment illustrates an example in which the connectors 50A, 50B have the same shape, and the connectors 50A, 50B are provided such that, when the heat exchange plates 32 are mounted in the housing case, the connectors 50A, 50B are positioned at a predetermined distance from each other. However, the present disclosure is not limited to such a configuration. For example, a protrusion may be provided at the distal end of one connector, and a recess may be provided at the distal end of the other connector. In this case, the protrusion and the recess may be shaped such that the distal end of the protrusion can be inserted into the recess.

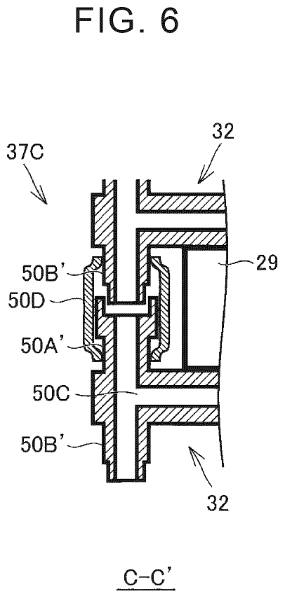

FIG. 6 illustrates the configuration of connectors 50A′, 50B′ and a connection pipe 50D in a modification.

As shown in FIG. 6, the connector 50B′ has a protruding cross-section (protrusion) in its distal end portion. More specifically, the connector 50B′ is formed such that its distal end portion has a smaller outer diameter than a middle portion of the cylindrical portion of the connector 50B′ in the front-rear direction L. The connector 50A′ has a recessed cross-section (recess) in its distal end portion. More specifically, the distal end portion of the connector 50A′ has an inner wall and an outer wall. The inner wall has a circular shape with an inner diameter larger than the outer diameter of the connector 50B′ as viewed in the front-rear direction L. The outer wall has an outer diameter smaller than the inner diameter of the connection pipe 50D.

In this configuration, the distal end of the protrusion of the connector 50B′ is inserted into the recess of the connector 50A′. This reduces application of the cooing medium pressure to the connection pipe 50D that covers the connectors 50B′, 50A′. It is therefore possible to reduce deterioration in durability of the connection pipe 50D due to the cooling medium pressure.

The above embodiment also illustrates an example in which the connection pipe 50D is inserted over both connectors 50A, 50B. However, for example, each of the connectors 50A, 50B may be configured such that at least the entire side surface of its cylindrical portion is coated with an insulating coating. In this manner, even when a large relative positional deviation occurs between the connectors 50A, 50B due to manufacturing tolerances, exposure of electrically conductive portions can be reduced when the connectors 50A, 50B are covered with the connection pipe 50D.

All or part of the modifications described above may be combined as appropriate. The embodiment disclosed herein should be considered to be illustrative in all respects and not restrictive. The scope of the present disclosure is set forth in the claims rather than in the above description, and is intended to include all modifications within the meaning and scope equivalent to the claims.

What is claimed is:

1. An energy storage device comprising:
a plurality of energy storage elements;
a first heat exchanger having a plate shape and disposed between the energy storage elements so as to face long side surfaces of the energy storage elements, the first heat exchanger extending in a longitudinal direction of the long side surfaces; and
a second heat exchanger having a plate shape and disposed so as to face the first heat exchanger, the second heat exchanger being configured to perform heat exchange with an opposite long side surface of the energy storage element from the long side surface, wherein:
a first connector is provided at a first end of the first heat exchanger in the longitudinal direction, the first connector having an opening that opens toward a second end of the second heat exchanger in the longitudinal direction;
a second connector is provided at the second end, the second connector having an opening that opens toward the first connector; and
the energy storage device further includes a member configured to contract upon heating, the member covering each of the first connector and the second connector.

2. The energy storage device according to claim 1, wherein each of the first connector and the second connector is coated with an insulating coating.

3. The energy storage device according to claim 1, wherein:
a protrusion is provided at a distal end of the first connector; and
a recess configured to receive a distal end of the protrusion is provided in a distal end of the second connector.

4. A method for manufacturing an electricity storage device, the method comprising:
disposing a first heat exchanger such that the first heat exchanger faces a long side surface of an energy storage element, the first heat exchanger having a plate shape and extending in a longitudinal direction of the long side surface; and
disposing a second heat exchanger such that the second heat exchanger faces the first heat exchanger, the second heat exchanger having a plate shape, and the second heat exchanger being configured to perform heat exchange with an opposite long side surface of the energy storage element from the long side surface, wherein:
a first connector is provided at a first end of the first heat exchanger in the longitudinal direction, the first connector having an opening that opens toward a second end of the second heat exchanger in the longitudinal direction;
a second connector is provided at the second end, the second connector having an opening that opens toward the first connector; and
the method further includes:
attaching, to the first connector, a member configured to contract upon heating;
attaching the member to the second connector when disposing the second heat exchanger; and
heating the member.
